(19) United States
(12) Patent Application Publication
(10) Pub. No.: US 2008/0222426 A1
(43) Pub. Date: Sep. 11, 2008

(54) Security Device

(75) Inventors: Geert Jan Schrijen, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/815,660

(22) PCT Filed: Jan. 26, 2006
(86) PCT No.: PCT/IB06/50283

§ 371 Date: Aug. 7, 2007

(30) Foreign Application Priority Data
Feb. 10, 2005 (EP) 05100956.1

(51) Int. Cl. H04L 9/32

(52) U.S. Cl. 713/186

(57) ABSTRACT

A security device comprising means for authenticating an entity using biometric data, characterized by means for alternatively authenticating the entity using a security code such as a personal identification number. Also a system configured to grant an authorization upon a successful authorization by the security device, in which the authorization granted after the authentication using the security code is restricted in scope compared to the authorization granted after the authentication using the biometric data.

The invention relates to a security device comprising means for authenticating an entity using biometric data.

The use of biometrics for identification or authentication has great advantages for the user in terms of user convenience. Instead of requiring keys, access cards or security codes such as passwords or personal identification numbers (PINs), an entity can be authenticated by simply taking a biometric measurement and comparing this measurement against reference data. A biometric cannot be lost or forgotten and is always present where the entity in question is. Typically the entity will be a person, but biometric authentication of animals or inanimate objects is also possible. An optical disc for example has certain physical properties that can be measured just like a person's fingerprint or iris.

An inherent disadvantage of the use of biometrics for authentication is the fact that you cannot easily give away this authentication means to someone else. For instance, if a person owns a car, he can lend the car to another person by simply handing over the key. But if the key can only be used after a successful biometric authentication, the other person cannot use the key unless the owner of the key accompanies him to perform the authentication.

International patent application WO 02/048973 (attorney docket PHUS000377) discloses a security system in which biometric data is used to authenticate different users of an account. For each user separate biometric data is recorded, so that each user can be authenticated using this biometric data. Each user can be assigned his or her own access level. A disadvantage of this system is that a new user who should be allowed to use the system must go through a biometric enrollment process to determine the biometric data. This is a complex and fault-prone process.

It is an object of the invention to provide a security device according to the preamble, with which it is possible to allow another entity to be successfully authenticated without the need for biometric authentication of the other entity.

This object is achieved according to the invention in a security device which is characterized by means for alternatively authenticating the entity using a security code such as a personal identification number.

By providing a security code such as a password or PIN as an alternative option for authentication, it becomes possible to allow use of the security device by another entity by simply informing this other entity what the security code is. The car owner in the example in the preamble can now simply tell the other person the PIN and no longer needs to perform the biometric authentication himself to allow use of the car.

One advantageous application is in situations where the owner of the security device is under duress. For instance, a robber may forcibly take an ATM card or access card to a secure facility. With traditional security cards that need biometric authentication, the robber may need to physically harm the owner to be able to successfully complete the biometric authentication. However with the present invention the owner can simply reveal the security code to avoid bodily injury.

Another advantage of the invention is that the security device can still be used when the biometric authentication fails, for example because the fingerprint sensor does not work. The owner of the device can still authenticate using the security code.

Preferably both means for authenticating use a single stored secret to determine if the authentication is successful. This can be realized by having the means for authenticating using biometric data verify whether a biometric measurement corresponds to the single stored secret and by having the means for authenticating using the security code verify whether an entered security code corresponds to the single stored secret.

In an embodiment the alternative authentication is enabled only after a successful authentication using the biometric data. This way the owner of the security device can decide himself whether to permit this alternative. In this embodiment the security code may be received as user input, e.g. through a numerical keypad provided on or with the security device, or through communication from another device such as a personal computer.

The means for alternative authentication are optionally enabled only for a predetermined period of time or for a predetermined number of operations, which period or number may be made user-configurable. This provides flexibility for the owner of the security device. For example, if he lends his car to another person, the period could be set to one week to force the other person to return the car after this one week.

It is possible that a secret used in at least one of the authentications is stored in a memory comprised in the security device. The input from the biometric measurement or the security code entered by the user is compared against this secret. That way the security device can independently decide whether the authentication is successful. Alternatively the secret used in the biometric authentication and/or the secret used in the alternative authentication can be stored in a remote location.

A system configured to grant an authorization upon a successful authorization by the security device of the invention may restrict the authorization granted after the authentication using the security code in scope compared to the authorization granted after the authentication using the biometric data. Since a security code is generally less secure than a biometric authentication, it makes sense to restrict what is permitted after an authentication using the security code.

For instance if the security device is an ATM terminal, then checking the balance of the associated bank account as well as unlimited withdrawal may be permitted after biometric authentication. In case of authentication using the security code, only checking the balance and withdrawal of up to 100 Euro might be permitted. If the security device grants access to a computer system, then read-only access might be permitted when authenticating using the security code, and read/write access might be permitted after biometric authentication.

These and other aspects of the invention will be apparent from and elucidated with reference to the illustrative embodiments shown in the drawings, in which:

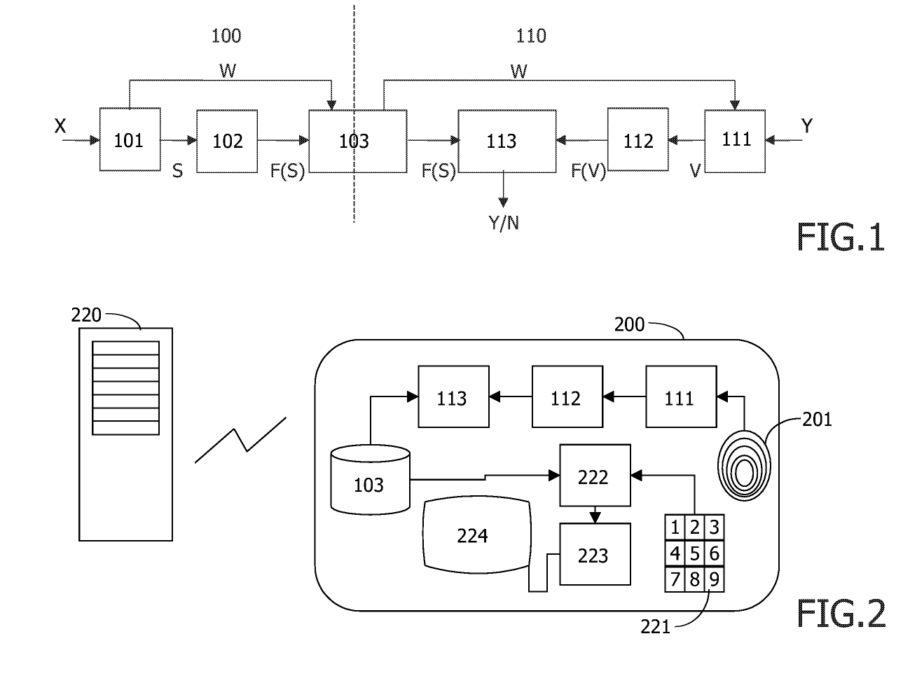

FIG. 1 schematically illustrates a process of enrolment and authentication using biometric data;

FIG. 2 schematically shows a security device in accordance with the present invention;

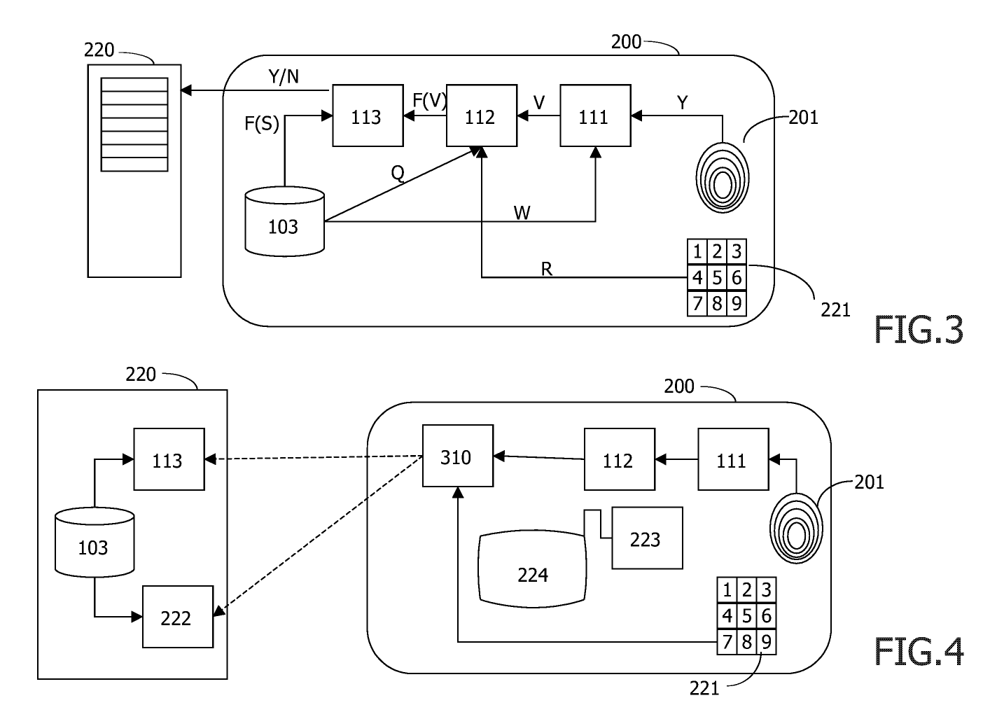

FIG. 3 illustrates another embodiment of the invention;

FIG. 4 shows an arrangement comprising the security device and a server; and

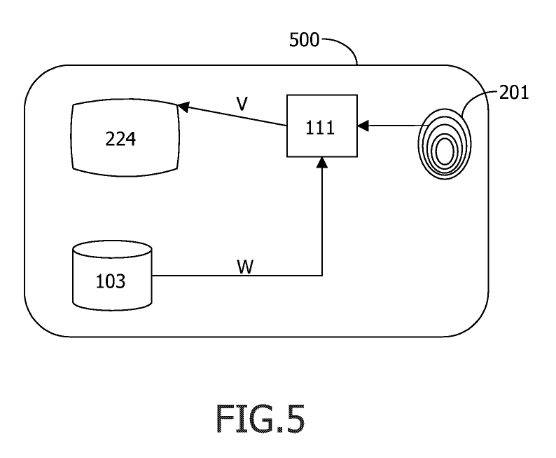

FIG. 5 illustrates an embodiment of the invention that enables retrieval of the security code.

Throughout the figures, same reference numerals indicate similar or corresponding features. Some of the features indicated in the drawings are typically implemented in software, and as such represent software entities, such as software modules or objects.

FIG. 1 schematically illustrates a process of enrolment and authentication using biometric data. In the enrolment stage 100, a reference biometric measurement X is taken from the entity involved. This measurement X is used in encoder 101 to obtain a secret S and helper data W. The secret S can be arbitrarily chosen, for example as user input. The helper data W is then chosen such that a later biometric measurement can be reliably transformed into the secret S, even when this later biometric measurement differs somewhat from the reference measurement. The helper data W is stored in a database 103.

In hashing module 102 a cryptographic hash function F such as SHA-1 or MD5 is applied to the secret S. The result F(S) is stored in the database 103 as well, associated with the helper data W. This way the secret S (and hence the biometric measurement, which can be reconstructed giving S and W) cannot be obtained by an attacker who gains unauthorized access to the database 103. Alternatively the secret S is stored directly.

During the authentication stage 110, decoder 111 transforms a biometric measurement Y together with the helper data W, obtained from the database 103, to obtain a secret V. Hashing module 112 applies the above-mentioned cryptographic hash function F to V to obtain F(V). Matching module 113 determines if F(S), obtained from the database 103, matches F(V). If so, the biometric authentication is successful.

This process is discussed in more detail in international patent application WO 04/104899 (attorney docket PHNL030552), as well as in European patent applications having serial number 04102609.7 (attorney docket PHNL040676) and 04104386.0 (attorney docket PHNL040985).

Other biometric authentication mechanisms may of course also be used. For instance the measurement X may be stored directly in the database 103 without any helper data W. Note that in some situations, performing a biometric authentication may involve performing multiple biometric measurements. For instance an iris scan and a fingerprint scan may be performed. This is often done to increase security and/or reliability of the biometric authentication mechanism. Although in the examples below only a single biometric measurement is used, it should be clear that multiple biometric measurements can be used as well.

FIG. 2 schematically shows a security device 200 in accordance with the present invention. The security device comprises the decoder 111, the hashing module 112, the matching module 113 and the database 103. A security device that is embedded in a terminal or system can be coupled to a large database that can hold helper data W and hash values F(S) of many users. A personal security card on the other hand typically only has a limited amount of storage, so only a few results F(S) may be stored in the database 103. This is not a problem, since the security card is normally used to authenticate only one person.

In an alternative embodiment (not shown) the database 103 is external to the security device 200. The security device 200 then contains a communication module that queries the external database to obtain F(S), so that the matching module 113 can determine if F(S) matches F(V).

A sensor to obtain the biometric measurement Y is in this embodiment comprised in the device as fingerprint sensor 201. Other types of sensors may of course also be employed, such as an iris scan sensor. Alternatively the sensor is external to the security device 200. The security device 200 then contains a communication module that receives the measurement Y from the external sensor.

The security device 200 in this embodiment obtains the biometric measurement Y and as above determines if the biometric authentication is successful or not. The results of the authentication are supplied to a server 220, which then may grant access to a certain facility or service, or allow one or more operations to be performed. For instance the server 220 may be an automated teller machine (ATM) that allows withdrawal of money from a bank account upon successful biometric authentication. The server 220 can also be configured to open a door or other entry mechanism upon successful biometric authentication, to grant physical access to e.g. a factory or office, to a restricted area of a building, to the contents of a vault or to a car. Many more examples may be thought of.

It will be appreciated that many of the components shown in FIG. 2 as part of the security device 200 can also be part of the server 220. For example the sensor 201 may be external to the security device and connected to the server 220. And the matching module 113 can also be installed in the server 220 instead of in the security device 200.

In accordance with the present invention, the security device 200 also comprises a numerical keyboard 221 using which a security code, in this case a personal identification number, can be entered. Alternatively an alphanumerical keyboard can be provided to accommodate passwords or passphrases. Yet alternatively an external input means can be used. For example the security code may be entered using a personal computer. The security device 200 then contains a communication module that receives the entered security code.

The entered security code is provided to verification module 222 which determines if this entered security code matches a reference security code stored in the database 103. Of course the reference security code can also be stored in a different storage medium, or even be stored external to the security device. In the latter case the security device 200 then contains a communication module that retrieves the reference security code and supplies it to the verification module 222 for said determination.

Preferably the reference security code is not stored itself. Rather, a cryptographically hashed version of the reference security code is stored. The verification module 222 then computes a cryptographically hashed version of the entered security code and determines if this matches the cryptographically hashed version of the reference security code.

The reference security code may have been input previously, e.g. using the numerical keyboard 221. It may also have been installed upon creation or activation of the security card 200.

The results of the authentication by the verification module 222 are supplied to the server 220, which then may grant access to a certain facility or service, or allow one or more operations to be performed. The granted access or permitted operation(s) may be identical to that granted or permitted after a successful biometric authentication. Alternatively the authorization granted after the authentication using the security code might be restricted in scope compared to the authorization granted after the authentication using the biometric data.

Optionally the alternative authentication using the security code is not enabled by default. The security device 200 then functions as an ordinary security device with biometric authentication. The owner of the security device 200 may choose to enable the alternative authentication when desired. Preferably this alternative authentication is enabled only after a successful authentication using the biometric data, to prove that it is really the owner who wishes to enable the alternative authentication.

To this end the security device 200 is provided with enabling module 223 that the owner can activate. This module 223 may comprise a button or switch to initiate the enabling. Alternatively a menu or option may be presented on a display 224 through which the alternative authentication can be enabled. The enabling module 223 then enables the alternative authentication if it receives from the matching module 113 an indication that biometric authentication was successful.

If the alternative authentication is enabled, then the reference security code needs to be determined. Preferably the security code is entered by the owner using keyboard 221. It can then be stored in the database 103 or in another memory. For added security only a cryptographically hashed version of the reference security code should be stored.

In another embodiment the enabling module 223 randomly or pseudo-randomly generates the reference security code and displays it on the display 224. This reduces the chance that an easy to guess code is used as the reference security code. The enabling module 223 may reject any easy to guess codes.

The alternative authentication is in an embodiment enabled only for a predetermined period of time. For instance the period can be chosen as one week. Preferably the period of time is user-configurable. It may then be entered by the owner with keyboard 221 or chosen from a menu.

The alternative authentication is in an embodiment enabled only for a predetermined number of operations. For instance the number can be chosen as one operation to permit a single usage by another person. Again preferably the number is user-configurable. It may then be entered by the owner with keyboard 221 or chosen from a menu.

FIG. 3 illustrates another embodiment of the invention. In this embodiment the biometric authentication and the authentication based on the security code are integrated. A hashed version F(S) of a reference secret S is stored in the database 103. This reference secret S may have been obtained during enrolment of the biometric authentication, as explained above with reference to FIG. 1. Alternatively the reference secret S may be a security code. In that case it may have been entered by the owner or it may have been determined during creation or activation of the security card 200.

A successful authentication now occurs if the user can provide a value V for which F(V) matches F(S). This may occur in two ways. First, the biometric measurement Y can be transformed into a secret V for which F(V) matches F(S), or the entered security code R can be hashed to obtain a hash F(R) that matches F(S). This has the advantage that only a single hash needs to be stored in the database 103 even though two authentication schemes are used.

In embodiments where the enabling of the alternative authentication is optional, it is advantageous to determine the reference secret S not arbitrarily but to determine it to conform to the rules for security codes. For instance, if four-digit PINs are used, the reference secret S should be determined as a four-digit number as well. Then, when enabling the alternative authentication, the security device 200 displays S on the display 224 to inform the owner.

It is also possible to make the alternative authentication optional and to allow the owner to choose an arbitrary security code that corresponds to the reference secret S. A biometric measurement is performed so that the decoder 111 can produce the secret V. This secret V should match the reference secret S if it is really the owner of the security device 200 whose biometric features are measured.

An arbitrarily chosen reference security code R is entered using keyboard 221. Now further helper data Q is computed such that a combination of this further helper data X and the reference security code R results in the secret V. For instance an XOR operation can be used: Q=R XOR V. With this value Q, now V can be found by V=R XOR Q. Q is stored in the database 103.

When the user now enters a security code R to authenticate himself this way, the hashing module 112 receives this value R and the value Q. Using these values V is computed and hashed to produce F(V). This value F(V) can be matched with F(S) in matching module 113 as usual.

Note that it is not possible to recover V (or S) given this value Q alone. However any reference security code can be entered, and this reference security code can be transformed into a value that matches a previously stored secret S.

In another embodiment the owner cannot choose the security code. This may be desirable e.g. if it is feared that the owner may choose easily guessed security codes, or if the security device 200 is not equipped with a keyboard. Now, when the alternative authentication is being enabled, the owner must first perform a biometric reading as above e.g. by presenting his finger on fingerprint sensor 201. Again the secret V that is obtained by the decoder 111 is identical to S, assuming it is the owner whose biometric property has been measured.

Hence now V can be used as the security code. The value of V can be shown on the display 224 to inform the owner that the security code has been initialized to this value. The owner can then provide another entity with the security code to enable that other entity to authenticate using the security code.

Optionally, before displaying the value of V it may be checked if F(V) equals F(S). This proves that it is really the owner of the security device 200 who enabled the alternative security code-based authentication.

The same can be done at a later time when the owner has forgotten the security code. Thus, by simply performing the biometric authentication his security code is shown. Again optionally, before displaying the value of V, it may be checked if F(V) equals F(S). This proves that it is really the owner of the security device 200 who requested the displaying of the security code.

In an embodiment the value of V is retained temporarily e.g. in a volatile memory in the security device 200 after it has been derived once. This means that the user does not need to present his finger to recall the security code. He can simply e.g. press a button, choose the option from a menu or otherwise request the feature, and the security device 200 displays the value of V. After a certain time, or upon deactivation of the security device 200 or if another stop-criterion is satisfied, the value of V is erased from its temporary storage.

In case the secret S equals the owner's security code and the database 103 in which F(S) is stored is publicly accessible, extra security measures are required. Normally it is infeasible to find S given F(S), but if the security code is a typical four-digit Personal Identification Number (PIN), it suddenly becomes possible to determine S from F(S). For a four-digit PIN, an exhaustive search to retrieve S from F(S) will require on the average 10⁴ divided by two or about 5,000 trials before S is found. In order to improve security S must be chosen much larger, for example in the order of 20 digits to achieve 64 bits security (a minimal requirement). Obviously a 20-digit PIN code is very user-unfriendly.

Instead of using such a large PIN for improved security it is also possible to use an additional secret key K which has a length of at least 64 bits to achieve reasonable security. Instead of storing F(S) in the database 103, now the value F(K∥S) is stored. Here denotes concatenation of bits. When the owner is authenticating herself, she also has to present a card or device that contains K. For example, K could be securely stored on the security device itself. The verifying terminal can then concatenate K with the reconstructed secret from the biometrics or the typed-in PIN by the user, hash it, and compare it to F(K∥S) in the database.

Note that these extra security measures (either using long PIN codes or using an additional key stored on some device or card) are only necessary if the database used by the verifier is public, since F(S) is stored on this database 103. If F(S) is stored in the security device 200, then it normally suffices if the security device 200 is protected against unauthorized reading out of information in the database 103.

In an alternative embodiment the reference secret S can simply be stored directly in the database 103 instead of storing F(S). However this is insecure, as S together with W can be used to reconstruct the biometric measurement X. That means an attacker can fool a later biometric authentication procedure by presenting X, for example by presenting a dummy finger with the correct (duplicated) fingerprint. So in this embodiment it is important to adequately protect the database 103 against unauthorized reading.

In this embodiment again the security code can be chosen as equal to S as above. It is now not necessary anymore to first perform a biometric measurement so as to obtain the secret V, as the (presumably equal) secret S can simply be retrieved from database 103. Hence now simply secret S can be presented to the owner as his new security code. Or alternatively, the further helper data Q can be computed as described above to allow for arbitrarily chosen security codes.

In FIGS. 2 and 3 the security device 200 is shown as a smart card that can be used to authorize one or more operations or access to a certain facility or service in conjunction with server 220. This is of course merely an illustrative example.

In an embodiment the security device 200 is comprised in a car key. The server 220 then preferably is installed inside a car. If either biometric or the alternative authentication is successful, the security device 200 signals this to the server 220, preferably over a secure authenticated channel, which opens the door and/or activates the engine of the car.

In another embodiment the server 220 is a personal computer. The security device 200 is then used to authorize access to said computer and/or to network services available to that computer. If the security device 200 is installed as a part of the personal computer, the computer's keyboard and display can be used in the place of keyboard 221 and display 224. However the security device 200 can also be provided as a separate card or module that needs to be installed in one of the computer's slots or that communicates wirelessly with the personal computer.

In another embodiment the security device 200 is comprised in a mobile phone, in which case the keyboard and the display of the mobile phone can be used. In addition, in this case the wireless communication capabilities of the mobile phone can be used to e.g. retrieve data from an external database or other location. The two authentication mechanisms can now be used to authorize activation of the mobile phone and/or access to the mobile telephony network.

In another embodiment the security device 200 is used to authorize financial operations at an automated teller machine (ATM). The owner of the device 200 presents the card to the ATM and authenticates himself using either the biometric or the alternative mechanism. The result of either authentication is signaled to the ATM, which then may permit withdrawal of a certain amount of money or another operation. In such an embodiment a secure and authenticated connection between the security device 200 and the ATM is desirable. Alternatively the security device can be embedded in the ATM in which case the connection is implicitly assumed to be secure and authentic.

FIG. 4 shows an alternative embodiment of the arrangement comprising the security device 200 and the server 220. In this embodiment, matching module 113, verification module 222 and database 103 are part of the server 220. The security device 200 now comprises a wireless communication module 310 by which the security device 200 communicates with the server 220.

In particular, the value F(V) produced by decoder 111 and hashing module 112 is now communicated to the server 220 for matching by matching module 113 with reference value F(S) stored in database 103. Similarly, when the owner enters a security code, the entered security code is communicated to the server 220 for verification by verification module 222 against the reference security code stored in the database 103.

This embodiment provides some added security because the reference security code is now safely stored in the server 200. However there are also some risks. If the security device 200 outputs a signal that indicates the owner or user of the device 200 has been authenticated successfully, an attacker can record that signal and repeat it at a later time. The server 220 will then mistakenly authorize the attacker.

However care should be taken to protect the wireless communication from security device 200 to server 220, especially to protect the entered security code. This transmission can be recorded and repeated (“replayed”) at a later time as well. A secure connection, e.g. using encryption, should be established.

Of course the database 103 may be stored at yet another location, so that the server 220 contacts it over a network to retrieve the reference value F(S).

FIG. 5 illustrates an embodiment of the invention that enables retrieval of the security code. This device 500 comprises the database 103, the fingerprint sensor 201, the decoder 111 and the display 224. When a person presents his or her finger on the sensor 201, the decoder 111 computes a secret V as explained earlier using the helper data W retrieved from the database 103. This secret V is presented on the display 224. Thus, this device 500 provides assistance to a person wishing to authenticate himself using the security device 200. The person can simply recall his security code by presenting his finger on the sensor 201 and then enter this security code on the keyboard 221 on the security device 200.

Note furthermore that it is not necessary for the database 103 in device 500 to store S or H(S) since no authentication takes place on device 500. Merely a security code V is presented on the display and it is checked later on the device 200 whether this is correct. So the authentication takes place at device 200.

It should be noted that the above-mentioned embodiments illustrate rather than limit the invention, and that those skilled in the art will be able to design many alternative embodiments without departing from the scope of the appended claims. For instance instead of a display an audio output could be used. The display 224 could be external to the security device 200.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the system claim enumerating several means, several of these means can be embodied by one and the same item of hardware. The mere fact that certain measures are recited in mutually different dependent claims does not indicate that a combination of these measures cannot be used to advantage.

1. A security device comprising means for authenticating an entity using biometric data, characterized by means for alternatively authenticating the entity using a security code such as a personal identification number, in which both means for authenticating use a single stored secret to determine if the authentication is successful, characterized in that the biometric data comprises helper data for use in determining whether a biometric measurement corresponds to a secret stored in the security device, and in which the secret comprises a cryptographically hashed version of the security code.

2. The security device of claim 1, further comprising means for enabling the alternative authentication only after a successful authentication using the biometric data.

3. The security device of claim 2, in which the means for enabling the alternative authentication comprise means for receiving the security code as user input.

4. The security device of claim 7, in which the means for enabling the alternative authentication are configured to derive the security code from at least part of the biometric data and to present the security code on an output.

5. The security device of claim 2, in which the means for alternative authentication are enabled only for a predetermined period of time or for a predetermined number of operations.

6. The security device of claim 1, in which the predetermined period of time or the predetermined number is user-configurable.

7. The security device of claim 1, in which a secret used in at least one of the authentications is stored in a memory comprised in the security device.

8. A system configured to grant an authorization upon a successful authorization by the security device of claim 1, in which the authorization granted after the authentication using the security code is restricted in scope compared to the authorization granted after the authentication using the biometric data.
